(19) United States
(12) Patent Application Publication
(10) Pub. No.: US 2022/0297567 A1
(43) Pub. Date: Sep. 22, 2022

(54) POWER CHARGE CONTROL METHOD, POWER CHARGE CONTROL APPARATUS, AND POWER CHARGE CONTROL SYSTEM

(71) Applicant: HONDA MOTOR CO., LTD., Tokyo (JP)

(72) Inventors: Yongbin Sun, Beijing (CN); Shoujun Wang, Beijing (CN); Yaxin Bao, Beijing (CN)

(21) Appl. No.: 17/697,022

(22) Filed: Mar. 17, 2022

(30) Foreign Application Priority Data
Mar. 19, 2021 (CN) 202110297906.4

(51) Int. Cl. B60L 53/68; B60L 53/62

(52) U.S. Cl. CPC B60L 53/68; B60L 53/62

(57) ABSTRACT

A power charge control method including acquiring a standard power range of a battery; sending the standard power range to a user terminal; receiving a power charge target value in the standard power range that is fed back by the user terminal according to the standard power range; and performing power charge control with respect to the battery according to the power charge target value.

### CROSS-REFERENCE TO RELATED APPLICATION

Priority is claimed on Chinese Patent Application No. 202110297906.4, filed Mar. 19, 2021, the content of which is incorporated herein by reference.

### TECHNICAL FIELD

The present disclosure relates to a technical field of a power charge control, particularly relates to a power charge control method, a power charge control apparatus, and a power charge control system.

### BACKGROUND ART

According to a trend of energy saving and environmental protection, a new energy vehicle has the characteristic of less pollution and lower energy consumption and represents a direction of the vehicle in the future. Particularly, an electric vehicle has the advantage of being relatively simple and mature in technology and can be charged at any place with a power supply such that the electric vehicle is widely applied in the field of household cars.

The conventional technology is lack of the control for the charge power during the power charge of the electric vehicle such that it is difficult to perform the power charge correctly according to a target charge power determined by a user.

### SUMMARY

The present disclosure is made to provide a power charge control method, a power charge control apparatus, and a power charge control system to solve the technical problem that the conventional technology is lack of the control for the charge power during the power charge of the electric vehicle and it is difficult to perform the power charge correctly according to a target charge power determined by a user.

According to a first aspect of the present disclosure, a power charge control method includes acquiring a standard power range of a battery; sending the standard power range to a user terminal; receiving a power charge target value in the standard power range that is fed back by the user terminal according to the standard power range; and performing power charge control with respect to the battery according to the power charge target value.

Furthermore, performing power charge control with respect to the battery according to the power charge target value includes acquiring a first current power value of the battery at a current moment; and performing the power charge control with respect to the battery according to both of the power charge target value and the first current power value of the battery at the current moment.

Furthermore, performing the power charge control with respect to the battery according to both of the power charge target value and the first current power value of the battery at the current moment further includes controlling to start the power charge with respect to the battery when the first current power value of the battery at the current moment is lower than the power charge target value; and controlling to stop the power charge with respect to the battery when the first current power value of the battery at the current moment is equal to or higher than the power charge target value.

After performing the control to start the power charge with respect to the battery when the first current power value of the battery at the current moment is lower than the power charge target value, the power charge control method further includes acquiring a second current power value of the battery at the current moment in real time; and controlling to stop the power charge with respect to the battery when the second current power value of the battery at the current moment is equal to or higher than the power charge target value.

After performing power charge control with respect to the battery according to the power charge target value, the power charge control method further includes acquiring a power charge state and a third current power value of the battery at a current moment, and sending the power charge state and the third current power value of the battery at the current moment to the user terminal.

Furthermore, controlling to start the power charge with respect to the battery when the first current power value of the battery at the current moment is lower than the power charge target value includes sending a generated power charge instruction to a battery controller configured to control the power charge of the battery by executing the power charge instruction.

The power charge control method according to the present disclosure further includes sending the standard power range to the user terminal by a remote controller; and receiving the power charge target value transmitted by the remote controller.

Furthermore, acquiring the standard power range of the battery includes acquiring the standard power range of the battery by a battery controller.

According to a second aspect of the present disclosure, a power charge control apparatus includes an acquisition module configured to acquire a standard power range of a battery; a sending module configured to send the standard power range to a user terminal; a receiving module configured to receive a power charge target value in the standard power range that is fed back by the user terminal according to the standard power range; and a control module configured to perform power charge control with respect to the battery according to the power charge target value.

According to a third aspect of the present disclosure, a power charge control system includes a battery; a vehicle controller configured to send a standard power range of the battery; and a user terminal configured to receive the standard power range and feedback a power charge target value in the standard power range according to the standard power range, wherein the vehicle controller is configured to perform power charge control with respect to the battery according to the power charge target value.

### Advantageous Effects of Invention

According to the above-described aspects of the present disclosure, a power charge control method, a power charge control apparatus, and a power charge control system are provided. The power charge control method includes acquiring a standard power range of a battery; sending the standard power range to a user terminal; receiving a power charge target value in the standard power range that is fed back by the user terminal according to the standard power range; and performing power charge control with respect to the battery according to the power charge target value. Accordingly, it is possible to solve the technical problem that the conventional technology is lack of the control for the charge power during the power charge of the electric vehicle and it is difficult to perform the power charge correctly according to a target charge power determined by a user

### BRIEF DESCRIPTION OF DRAWINGS

FIG. 1 is a flowchart showing a batter power charge control method according to a first embodiment of the present disclosure.

FIG. 2 is a flowchart showing a batter power charge control method according to a modification example of the first embodiment of the present disclosure.

FIG. 3 is a flowchart showing a batter power charge control method according to a modification example of the first embodiment of the present disclosure.

FIG. 4 is a schematic view showing a battery power charge apparatus according to a second embodiment of the present disclosure.

FIG. 5 is a schematic view showing a battery power charge system according to a third embodiment of the present disclosure.

FIG. 6 is a schematic view showing a battery power charge system according to a modification example of the third embodiment of the present disclosure.

### DESCRIPTION OF EMBODIMENTS

In order to more clearly explain the technical problems, technical configurations and effects of the present disclosure, the present disclosure will be described in more details with reference to the figures and embodiments shown below. Here, the specific embodiments are described for the purpose of explaining the configuration of the present disclosure rather than limiting the present disclosure. The drawings used in the following description are some embodiments of the present disclosure and those skilled in the art may refer to these drawings and further obtain other related drawings.

In order to further clarify the above and other features and advantages of the present disclosure, the present disclosure will be described below with reference to the figures. It should be understood that each embodiment in the present description is only the example for descripting the present disclosure to those skilled in the art and is not intended to limit the present disclosure.

In the following description, a specific detailed description will be used to deepen the understanding of the present disclosure. However, it is clear to those skilled in the art that it is not necessary to realize the present disclosure using such detailed description. Other well-known steps or operations are not described so as to avoid obscuring the features of the present disclosure.

### First Embodiment

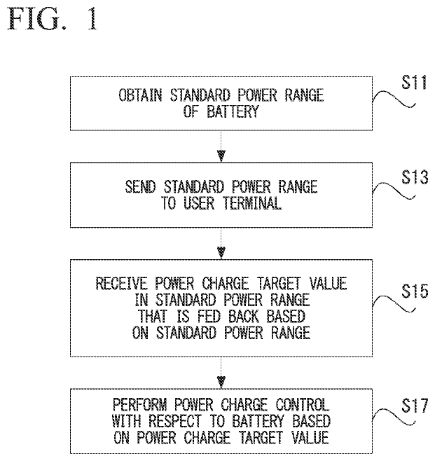

The present disclosure provides a battery power charge control method, and the method may be applied to an electric vehicle. As shown in FIG. 1, the method includes the following steps.

In Step S11, a standard power range of a battery is acquired.

More specifically, in the present embodiment, it is possible to acquire the standard power range of the battery by a vehicle controller. Here, the vehicle controller is configured to be able to acquire the standard power range of the battery via a battery controller.

It should be described that the standard power range means a usable range of a state of charge of the battery, and the state of charge (hereinafter referring to as “SOC”) is a percentage of a dischargeable capacity of the battery at the current moment based on a predetermined discharge condition with respect to a usable capacity of the battery. Generally, the percentage of in the SOC range is the range between 0% and 100%; however, due to the reaction characteristics of the chemical battery, that is, in consideration of the threshold boundary, the static and dynamic variances, the magnification variance, and the estimation accuracy variance or the like, it is necessary to prepare a buffer region for the estimation value of SOC to ensure that the battery is always operating in a safe range. Accordingly, in an actual operation, it is possible to ensure that the battery is used safely by determining a SOC usable range and causing the battery to operate in the SOC usable range.

Here, the above-described standard power range of the battery may be stored in the battery controller in advance, or determined by a human, or determined according to a real-time state of the battery (for example, consumption of the battery or usage time of the battery). Different types and different brands of the batteries have different characteristic such that the SOC usable ranges are different from each other.

In Step S13, the standard power range is sent to a user terminal.

More specifically, in the present embodiment, the vehicle controller transmits the standard power range of the battery that is sent by the battery controller to a remote controller, and then the standard power range of the battery is sent to the user terminal by the remote controller. It should be described that the user terminal may be a terminal device (mobile phone, tablet terminal, and electrical key) configured to execute mobile applications.

In Step S15, the power charge target value that is fed back by the user terminal according to the standard power range is received. Here, the power charge target value is in the standard power range.

More specifically, in the present embodiment, the vehicle controller receives the power charge target value that is fed back by the user terminal according to the standard power range and transmitted by the remote controller. Here, the power charge target value is in the standard power range.

It should be clarified that the battery is a chemical product, and the energy form thereof is a mutual conversion of the chemical energy and the electrical energy while the charge-discharge curves are non-linear. Here, the SOC usable range is effected by the factors such as the capacity, the energy, and the power of the battery, the environmental temperature, the temperature rise rate, the current magnification and the like. The SOC usable range is different in different operation condition, that is, the SOC usable ranges of different types of batteries are different from each other, and even in the same battery, the SOC usable range may be different due to the state such as the different environmental temperature, the consumption degree (actual capacity) and the like. Focusing on the safety considerations, it is preferable that the actual charge power target value is set within the safety range. That is, the actual charge power target value should be set within the standard power range.

In Step S17, the power charge control is performed with respect to the battery according to the power charge target value.

More specifically, in the present embodiment, the vehicle controller sends a control instruction to the battery controller according to the power charge target value and the battery controller performs the power charge control with respect to the battery according to the control instruction. As an option, in the present embodiment, the power charge control may be performed according to the power charge target value that is set in advance until the power charge target value is reached.

According to the present embodiment, compared with the conventional technology, the technical problem in which it is difficult to precisely perform the power charge according to the power charge target power by setting the power charge target power in the SOC usable range of the battery based on the desire of the user. Also, it is possible for the battery to operate in the safe range to improve the safety by setting the power charge target power in the SOC usable range of the battery.

As an option, in Step S17, the power charge control with respect to the battery according to the power charge target value includes the following step.

In Step S171, a first current power value of the battery at the current moment is acquired.

More specifically, in the present embodiment, before performing the power charge with respect to the battery for the first time, the vehicle controller acquires the first current power value of the battery at the current moment via the battery controller. It should be clarified that the battery controller is configured to acquire parameters such as the voltage, the current, and the temperature of the battery, and then calculate the state of charge (SOC) of the battery at the current moment based on the parameters such as the voltage, the current, and the temperature of the battery. The state of charge (SOC) indicates the surplus power of the battery. In other words, the first current power value of the battery at the current moment is the surplus power of the battery.

In Step S172, the power charge with respect to the battery is performed according to the power charge target value and the first current power value of the battery at the current moment.

More specifically, in the present embodiment, the vehicle controller generates a control instruction according to the power charge target value and the first current power value of the battery at the current moment and sends the control instruction to the battery controller. The battery controller performs the power charge control with respect to the battery according to the control instruction sent by the vehicle controller.

As an option, in Step S172, performing the power charge with respect to the battery according to the power charge target value and the first current power value of the battery at the current moment includes the following steps.

In Step S1721, when the first current power value of the battery at the current moment is lower than the power charge target value, the control for starting the power charge is performed with respect to the battery.

More specifically, in the present embodiment, the vehicle controller receives the first current power value of the battery at the current moment that is sent by the battery controller and the power charge target value that is fed back by the user terminal according to the standard power range, and then compares the first current power value with the power charge target value. When the first current power value is lower than the power charge target value, the vehicle controller generates a power charge start instruction and sends the power charge start instruction to the battery controller. The battery controller performs the power charge with respect to the battery according to the power charge start instruction.

In Step S1724, when the first current power value of the battery at the current moment is equal to or larger than the power charge target value, the power charge with respect to the battery is stopped.

More specifically, in the present embodiment, the vehicle controller receives the first current power value of the battery at the current moment that is sent by the battery controller and the power charge target value that is fed back by the user terminal according to the standard power range, and then compares the first current power value with the power charge target value. When the first current power value is equal to or higher than the power charge target value, it means that it is not necessary to receive power. In the present embodiment, the vehicle controller generates a power charge stop instruction and sends the power charge stop instruction to the battery controller. The battery controller stops the power charge with respect to the battery according to the power charge stop instruction.

As an option, in Step S1721, after performing the control to start the power charge with respect to the battery when the first current power value of the battery at the current moment is lower than the power charge target value, the method includes the following steps.

In Step S1722, a second current power value of the battery at the current moment is acquired in real-time.

More specifically, in the present embodiment, when the power charge with respect to the battery is started, the vehicle controller acquires the second current power value of the battery at the current moment via a sensor of the battery. It should be clarified that the battery controller is configured to acquire parameters such as the voltage, the current, and the temperature of the battery, and then calculate the state of charge (SOC) of the battery at the current moment based on the parameters such as the voltage, the current, and the temperature of the battery. The state of charge (SOC) may indicate the real-time power during the power charge process of the battery. In other words, the second current power value of the battery at the current moment is the real-time power value of the battery during the power charge process of the battery.

In Step S1723, when the second current power value of the battery at the current moment is equal to or higher than the power charge target value, the control for stopping the power charge with respect to the battery is performed.

More specifically, in the present embodiment, the vehicle receives the second current power value of the battery at the current moment that is sent by the battery controller and then compares the second current power value with the power charge target value. When the second current power value is equal to or higher than the power charge target value, the vehicle controller generates a power charge termination instruction and sends the power charge termination instruction to the battery controller. The battery controller terminates the power charge with respect to the battery according to the power charge termination instruction.

As an option, in Step S17, after the control for the power charge to the battery according to the power charge target value is performed, the method includes the following steps.

In Step S18, a current power charge state of the battery and a third current power value of the battery at the current moment are acquired.

In Step S19, the current power charge state of the battery and the third current power value of the battery at the current moment are sent to the user terminal.

More specifically, in the present embodiment, the vehicle controller acquires the current power charge state of the battery and the third current power value of the battery at the current moment via the battery controller, and then sends the current power charge state of the battery and the third current power value of the battery at the current moment to the remote controller. The current power charge state of the battery and the third current power value of the battery at the current moment are sent to the user terminal by the remote controller. The user may intuitively understand the current power charge state of the battery and the current power value of the battery through the user terminal.

As an option, in Step S1721, controlling the battery to start the power charge when the first current power value of the battery at the current moment is lower than the power charge target value includes the following steps.

In Step S17211, the generated power charge instruction is sent to the battery controller. Here, the battery controller is configured to control the battery to perform the power charge by executing the power charge instruction.

More specifically, in the present embodiment, the vehicle controller compares the received first current power value with the power charge target value, and when the first current power value is lower than the power charge target value, the vehicle controller generates the power charge instruction. The vehicle controller sends the generated power charge instruction to the battery controller, and the battery controller performs the power charge with respect to the battery according to the power charge instruction.

According to the present embodiment, compared with the conventional technology, before the power charge with respect to the battery, during the power charge with respect to the battery, and after the power charge with respect to the battery, the vehicle controller is able to adjust the strategy of the power charge control according to the real-time power of the battery by monitoring the power of the battery in real-time. Accordingly, it is possible to maintain battery health by avoiding the phenomenon that affects the battery health due to overcharging to the battery. In other words, the effect of extending the service life of the battery may be achieved.

As an option, in the above-described Step S11 to Step S17, the vehicle controller according to the present embodiment sends the standard power range to the user terminal via the remote controller, and the vehicle controller receives the power charge target value that is transmitted by the remote controller.

More specifically, in the present embodiment, the vehicle controller sends the standard power range to the user terminal via the remote controller. Here, the remote controller is a module in the electric vehicle and the remote controller is configured to send and receive the information sent from the vehicle controller and the user terminal. The remote controller may be a controller in a car internet or a module configured to realize other communication functions. The vehicle controller receives the power charge target value transmitted by the remote controller; here, the power charge target value is determined by the user terminal according to the standard power range that is sent by the remote controller.

As an option, in Step S11, acquiring the standard power range of the battery includes the following steps.

The standard power range of the battery is acquired via the battery controller.

More specifically, in the present embodiment, the battery controller collects the state information of the battery to determine the SOC of the battery according to the state information of the battery and then determines the standard power range of the battery according to the SOC of the battery. The battery controller sends the standard power range of the battery to the vehicle controller.

As an option, in the present embodiment, the user terminal receives the standard power range and then the user terminal determines the power charge target value. At last, the user terminal outputs the power charge target value. The user terminal receives the standard power range sent by the remote controller and the above-described standard power range sent by the battery controller is transmitted to the remote controller by the vehicle controller, and the user terminal determines the power charge target value in the standard power range. The user terminal sends the determined power charge target value to the remote controller, and the determined power charge target value is transmitted to the vehicle controller by the remote controller.

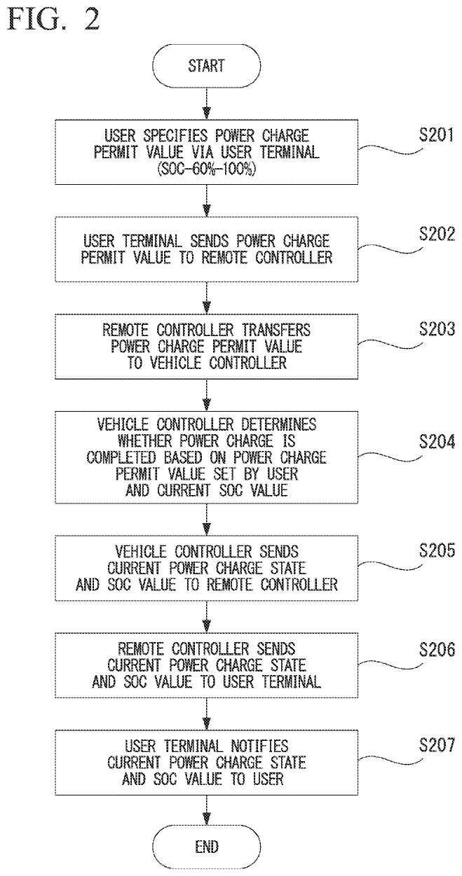

As shown in FIG. 2, another embodiment of the present disclosure including the following steps are disclosed.

In Step S201, the user specifies an allowable charge power (SOC 60% to 100%) through the user terminal. In Step S202, the user terminal sends the allowable charge power to the remote controller. In Step S203, the remote controller sends the allowable charge power to the vehicle controller. In Step S204, the vehicle controller determines whether the power charge has been completed according to the determined allowable charge power and the current SOC value. In Step S205, the vehicle controller sends the current power charge state and the SOC value to the remote controller. In Step S206, the remote controller sends the current power charge state and the SOC value to the user terminal. In Step S207, the user terminal notifies the current power charge state and the SOC value to the user.

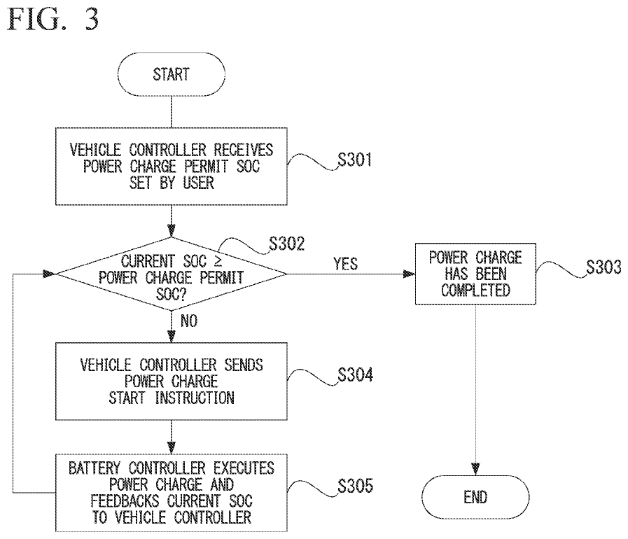

As shown in FIG. 3, in Step S204, determining whether the power charge has been completed by the vehicle controller according to the determined allowable charge power and the current SOC value includes the following steps.

In Step S301, the vehicle controller may receive an allowable charge power SOC that is determined by the user, and the allowable charge power SOC may be the power charge target value.

In Step S302, it is determined whether the current SOC is equal to or larger than the allowable charge power SOC. In a case in which the current SOC is equal to or larger than the allowable charge power SOC (YES), the method proceeds to Step S303 to execute. In a case in which the current SOC is smaller than the allowable charge power SOC (NO), the method proceeds to Step S304 to execute.

In Step S303, the power charge is completed and the process is terminated.

In Step S304, the vehicle controller outputs the power charge start instruction.

In Step S305, the battery controller performs the power charge and feeds back the current SOC to the vehicle controller.

### Second Embodiment

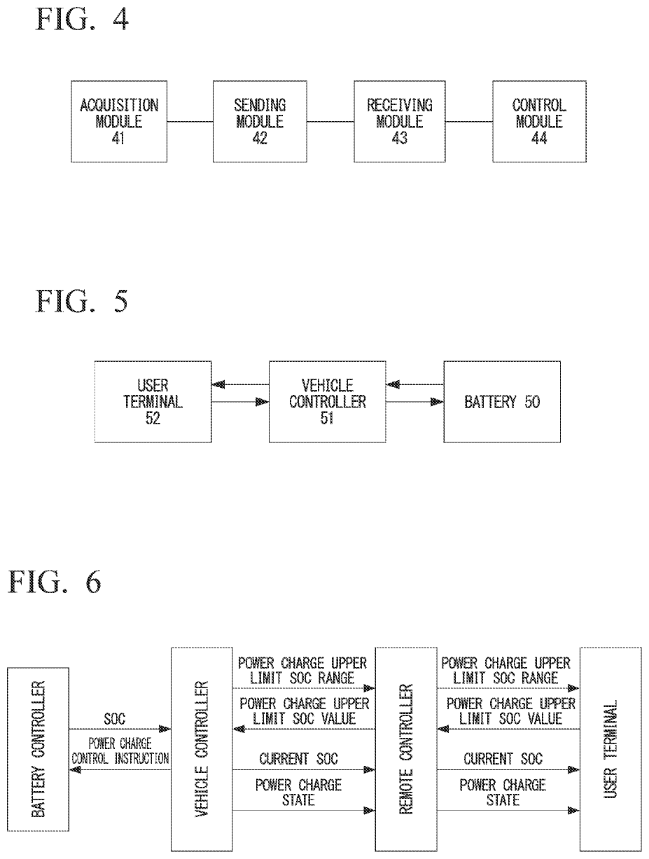

The present disclosure provides a power charge control apparatus, and the power charge control apparatus may be adopted in the electric vehicle. The power charge control apparatus may be the vehicle controller. As shown in FIG. 4, the power charge control apparatus includes the following configurations.

An acquisition module 41 is configured to acquire a standard power range of a battery. A sending module 42 is configured to send the standard power range to a user terminal. A receiving module 43 is configured to receive a power charge target value in the standard power range that is fed back by the user terminal according to the standard power range. A control module 44 is configured to perform power charge control with respect to the battery according to the power charge target value.

According to the present embodiment, compared with the conventional technology, it is possible to set the power charge target value according to the will of the user in the SOC usable range of the battery. Accordingly, the technical problem in which it is difficult to precisely perform the power charge according to the power charge target power set by the user is solved. Also, the power charge target value is set in the SOC usable range of the battery such that it is ensured that the battery operates in the safe range to improve the safety.

### Third Embodiment

The present disclosure provides a power charge control system, and the power charge control system may be adopted in the electric vehicle. As shown in FIG. 5, the power charge control system includes the following configurations.

The power charge control system includes a battery 50, a vehicle controller 51 and a user terminal 52, wherein the vehicle controller is configured to output a standard power range of the battery 50. The user terminal 52 is configured to receive the standard power range and feedback a power charge target value according to the standard power range. Here, the power charge target value is in the standard power range. The vehicle controller 51 is configured to control the power charge with respect to the battery according to the power charge target value.

According to the present embodiment, compared with the conventional technology, it is possible to set the power charge target value according to the will of the user in the SOC usable range of the battery based on the characteristic of each of different types and different brands of batteries. Accordingly, it is possible to solve the technical problem in which after the power charge is performed until charging to a specified target power desired by the user, it is necessary for the user to continuing observing at any time for stopping the power charge and time and effort is necessary. Also, the power charge target value is set in the SOC usable range of the battery such that it is ensured that the battery operates in the safe range to improve the safety.

As shown in FIG. 6, the present disclosure provides the following embodiment as an option.

The battery controller sends the battery SOC to the vehicle controller, and then the vehicle controller generates a power charge SOC upper range and sends the power charge SOC upper range to the remote controller. The remote controller transmits the power charge SOC upper range to the user terminal. The user determines a power charge SOC upper value according to the power charge SOC upper range and sends the power charge SOC upper value to the remote controller. The remote controller transmits the power charge SOC upper value determined by the user to the vehicle controller. The vehicle controller generates a power charge control instruction according to the power charge SOC upper value, and transmits the power charge control instruction to the battery controller. The battery controller performs the power charge with respect to the battery according to the power charge control instruction while monitoring the current SOC of the battery in real-time and sending the current SOC to the vehicle controller. The vehicle controller sends the current SOC and the power charge state to the remote controller. The remote controller transmits the received current SOC and the power charge state to the user terminal.

It should be clarified that, in the present specification, the specific features, operations and details of the method according to the present disclosure described above can be applied to the apparatus and system according to the present disclosure. On the other hand, in the present specification, the specific features, operations and detailed contents according to the apparatus and system according to the present disclosure described above can also be applied to the method according to the present disclosure. Also, each step of the method according to the present disclosure described above can be performed by the corresponding component or element of the apparatus or system according to the present disclosure.

It should be understood that each module/element of the device according to the present disclosure may be realized in whole or in part by the software, the hardware, the firmware, or a combination thereof. Each of the above-described module/element is embedded in a processor of a computer equipment in the form of hardware or firmware, or is independent from the processor, or stored in a storage of the computer equipment in the form of software and loaded by the processor so as to execute the operations of each module/element. Each of the above-described module/element is realized as an independent member or module, or two or more modules/elements are realized as one member or module.

In an embodiment, a computer equipment with a storage and a processor is provided. The above-described storage stores computer instructions for the processor to execute. By executing the above-described computer instructions by the above-described processor, each step of the method according to the present disclosure may be executed by the processor. This computer equipment may be, in a broad sense, a server, a terminal apparatus, or any other electronic equipment with the required computing and/or processing power. In an embodiment, the computer equipment may include a processor, a storage, a network interface, and a communication interface connected through a system bus. The processor of the computer equipment is configured to provide the required computing, processing, and/or control capabilities. The storage of the computer equipment may have a non-volatile storage media and a memory. The non-volatile storage media may store operating systems and computer programs therein. This memory may provide an environment for running the operating systems and computer programs on the non-volatile storage media. The network interface and the communication interface of the computer equipment are used for network connection and communication with any external equipment. When the computer programs are executed by the processor, each step of the battery charge method according to the present disclosure will be executed.

The present invention may be realized by a computer-readable storage medium in which the computer program is stored. When the computer program described above is executed by the processor, the steps of the method according to the present disclosure are performed. In one embodiment, the computer programs described above are distributed across a plurality of computer equipment or processors coupled on a network. Accordingly, the computer programs described above are stored, accessed, and executed in a distributed manner by one or more computer equipment or processors. One method step/operation, or two or more method steps/operations may be performed by one computer equipment or processor, or by two or more computer equipment or processors. One or more method steps/operations may be performed by one or more computer equipment or processors, and one or more other method steps/operations may be performed by one or more other computer equipment or processors. One or more computer equipment or processors may perform one method step/operation, or two or more method steps/operations.

It will be understood by those skilled in the art that each step of the method according to the present disclosure may be realized by using computer program to instruct the corresponding hardware such as the computer equipment or the processor. The computer program described above may be stored in a non-temporary computer-readable storage medium. When the computer program is executed, each step of the method according to the present disclosure is executed. Depending on the circumstances, the storage, the memory, the databases and other media included in the present specification may include volatile and/or non-volatile memory. Examples of the non-volatile memories include the read-only memory (ROM), the programmable ROM (PROM), the electrically programmable ROM (EPROM), the electrically erasable programmable ROM (EEPROM), the flash memory, the magnetic tape, the floppy disks, the magnetic and optical data storage devices, the optical data storage devices, the hard disks, the solid state disks and the like. Examples of the volatile memory include, for example, the random access memory (RAM), the external cache memory, and the like.

The technical features described above can be arbitrarily combined. It is noted that all possible combinations of the technical features are not described; however, any combinations of these technical features should be included in the scope of the present disclosure as long as they are not inconsistent.

Although some embodiments of the present disclosure have been described, these embodiments are presented only as examples and they are not intended to limit the scope of the present disclosure. These embodiments can be implemented in various other embodiments, and various omissions, replacements, and changes can be made without departing from the spirit of the present disclosure. These embodiments and variations thereof are included in the scope of the present disclosure described in the claims and the equivalent scope thereof, as are included in the scope and spirit of the present disclosure.

What is claimed is:

1. A power charge control method, comprising:
acquiring a standard power range of a battery;
sending the standard power range to a user terminal;
receiving a power charge target value in the standard power range that is fed back by the user terminal according to the standard power range; and
performing power charge control with respect to the battery according to the power charge target value.

2. The power charge control method according to claim 1,
wherein performing power charge control with respect to the battery according to the power charge target value comprising:
acquiring a first current power value of the battery at a current moment; and
performing the power charge control with respect to the battery according to both of the power charge target value and the first current power value of the battery at the current moment.

3. The power charge control method according to claim 2,
wherein performing the power charge control with respect to the battery according to both of the power charge target value and the first current power value of the battery at the current moment further comprising:
controlling to start the power charge with respect to the battery when the first current power value of the battery at the current moment is lower than the power charge target value; and
controlling to stop the power charge with respect to the battery when the first current power value of the battery at the current moment is equal to or higher than the power charge target value.

4. The power charge control method according to claim 3,
wherein after performing the control to start the power charge with respect to the battery when the first current power value of the battery at the current moment is lower than the power charge target value,
acquiring a second current power value of the battery at the current moment in real time; and
controlling to stop the power charge with respect to the battery when the second current power value of the battery at the current moment is equal to or higher than the power charge target value.

5. The power charge control method according to claim 1,
wherein after performing power charge control with respect to the battery according to the power charge target value,
acquiring a power charge state and a third current power value of the battery at a current moment, and
sending the power charge state and the third current power value of the battery at the current moment to the user terminal.

6. The power charge control method according to claim 3,
wherein controlling to start the power charge with respect to the battery when the first current power value of the battery at the current moment is lower than the power charge target value comprising:
sending a generated power charge instruction to a battery controller configured to control the power charge of the battery by executing the power charge instruction.

7. The power charge control method according to claim 1, further comprising:
sending the standard power range to the user terminal by a remote controller; and
receiving the power charge target value transmitted by the remote controller.

8. The power charge control method according to claim 1, wherein acquiring the standard power range of the battery comprising acquiring the standard power range of the battery by a battery controller.

9. A power charge control apparatus, comprising:
an acquisition module configured to acquire a standard power range of a battery;
a sending module configured to send the standard power range to a user terminal;
a receiving module configured to receive a power charge target value in the standard power range that is fed back by the user terminal according to the standard power range; and
a control module configured to perform power charge control with respect to the battery according to the power charge target value.

10. A power charge control system, comprising:
a battery;
a vehicle controller configured to send a standard power range of the battery; and
a user terminal configured to receive the standard power range and feedback a power charge target value in the standard power range according to the standard power range,
wherein the vehicle controller is configured to perform power charge control with respect to the battery according to the power charge target value.
